(19) United States
(12) Patent Application Publication
(10) Pub. No.: US 2004/0015816 A1
(43) Pub. Date: Jan. 22, 2004

(54) Coordination synthesis for software systems

(76) Inventors: Kenneth Joseph Hines, Kenmore, WA (US); Ross Benito Ortega, Seattle, WA (US)

Correspondence Address: STOEL RIVES LLP, 900 SW FIFTH AVENUE, SUITE 2600, PORTLAND, OR, 97204, US

(21) Appl. No.: 10/040,971

(22) Filed: Jan. 4, 2002

Related U.S. Application Data
(60) Provisional application No. 60/260,060, filed on Jan. 5, 2001.

(51) Int. Cl. G06F 9/44; G06F 9/45

(52) U.S. Cl. 717/101; 717/106; 717/144; 717/155; 717/156

(57) ABSTRACT

A goal of the present invention is to allow programmers to build software systems without regard to a specific target hardware architecture on which the software system will be implemented. An aspect of this is a high-level, coordination-centric, design methodology that permits programmers to explicitly declare the way control and data interactions between software components are coordinated. Coordination synthesis generates selectively optimizable implementation code to implement the coordination-centric software application on a target hardware architecture, and generates appropriate coordination code to implement the coordination scheme for the software application with the target hardware architecture's supported interaction protocols. The present invention transforms this abstract coordination between software components into concrete interactions for the interaction protocols provided by a target hardware architecture and further generates runtime support for each processing resource of the target hardware architecture for the software components running on that processing resource.

### RELATED APPLICATIONS

This application is a continuation of, and claims priority from, U.S. Provisional Patent Application No. 60/260,060 filed Jan. 5, 2001, which is incorporated herein by reference.

### TECHNICAL FIELD

The present invention relates to a system and method for the automated generation of a software application for use with a target hardware architecture.

### BACKGROUND OF THE INVENTION

A growing number of modern software systems are implemented on distributed hardware architectures. A distributed hardware architecture usually has several independent computational, or processing, resources and a framework, or interaction protocol, for interaction between those computational resources (e.g., higher-level protocols such as remote procedure call (RPC) and distributed shared memory (DSM); medium-level protocols such as TCP/IP, and UDP; and lower-level protocols such as I²C, PCI, and Ethernet). A software system for use with a distributed hardware architecture is often best designed by a specialized programmer with knowledge of, and expertise with, the specific interaction protocols used in the distributed hardware architecture. The specialized programmer preferably should also have a good understanding of any quirks associated with the specific interaction protocols used in the distributed hardware architecture. In addition to the above, the specialized programmer will often need to hard-code the interaction protocol into the software system, i.e. the software system will be written specifically for the interaction protocols used by the distributed hardware architecture on which the software system will be deployed. This makes the deployment of the software system explicit, inflexible, and difficult to re-target for a second target hardware architecture (even if the only difference between the original target hardware architecture and the second target hardware architecture is in the interaction protocols between the processing resources).

There remains a need for a way to design and implement a software system without entangling the design of the software system with the complexities and peculiarities of a particular target hardware architecture on which the software system will be deployed, and to automatically generate source code to implement the software system on a chosen target architecture. Given the variety of embedded systems available, there is a need for software systems to be portable, i.e. a need for software systems that can be deployed to alternative target hardware architectures without starting the design process from, or near, the beginning for each alternative target hardware architecture. Available code generation systems do not fulfill this need. Furthermore, other code generation systems usually are better suited to generating code that is to be implemented on a target hardware architecture having a single processing resource rather than a hardware architecture having several independent processing resources: In addition, other code generation systems often lack the capability of optimizing any generated implementation code for a distributed hardware architecture.

While hardware system design in some circumstances has achieved greater reusability and better optimization from explicitly separating elements of the system that deal with control from those that deal with data flow the design of software systems has not taken a similar approach. Similar separation of control and dataflow can likewise lead to similar benefits in the design of software systems. Typically software systems do not separate control and dataflow in this way, in part because explicit separation of control and data flow can complicate the design of a software system. Furthermore, explicit separation of control and data flow can interfere with the modularity of a software system.

For example, procedure calls can be used as a simple form of coordination between software modules. However, procedure calls have both control and data flow aspects. When a procedure call is invoked, the control aspect of the procedure call causes a calling component to block, while awaiting a return value from a called component. The control aspect also causes the called component to arrange all incoming calls so that the calls don't collide. In a conventional design environment, programmers need not concern themselves with details regarding the control and data flow involved in this procedure call. The programmer normally only needs to know that the calling component continues after the procedure call with any data obtained by the call. However, protocols such as procedure call (PC) are limited in their generality, and as a result programmers often can still have to deal with explicit control and data flow at a higher level of the design.

Prior art systems have attempted to solve some of the problems mentioned above. For example, a University of Washington Ph.D. dissertation by Pai Chou entitled Control Composition and Synthesis of Distributed Real-Time Embedded Systems (1998) (hereinafter Chou), disclosed a system for generating software application implementation code based on the explicit control aspects of the software system. Chou operates on the assumption that the software system has either local shared memory within a given processor, or communication when the target hardware architecture includes multiple processors, to provide support for control aspects of the software system. The system disclosed in Chou is essentially limited to the above assumptions because Chou's system is ill suited for generating implementation code when the target hardware architecture supports control aspects of a software system other than by local shared memory for single processor systems or communication for distributed architectures.

Another such prior art system was disclosed in a University of Washington Ph.D. dissertation by Ross Ortega entitled Communication Synthesis for Embedded Systems (2000) (hereinafter Ortega). Ortega teaches a system for implementing software systems on distributed hardware architectures based on a method of coordinating software components through the use of communication between the software components. This form of coordination limits the ability of Ortega to generate optimized source code for distributed systems because it can not take advantage of other forms of coordination provided by target hardware architectures. Ortega essentially converts all forms of coordination between components to communication between those components, regardless of the methods of coordination provided by the target hardware architecture. For that reason the Ortega system can not optimize implementation code for a variety of target system architectures.

Other examples of code generation methodologies currently in use include the following: generation from the unified modeling language (UML); generation from system description language (SDL); and generation from a digital signal processing paradigm (DSP generation).

UML is based on an object oriented system design paradigm. The code generated by UML is normally an object oriented template for various languages such as Java or C++, and requires the functional code to be manually added by the designer. UML code generators are not able to perform semantic analysis on the input specification, and are therefore unable to perform significant optimizations. Since the generated code must be manually edited, the UML code generation methodologies usually can not generate fully functional software systems.

There are several code generation tools that use SDL as an input language. While some of these code generation tools have gained popularity in some industries, the code generated by such tools is frequently hand edited by a programmer before being released in a product. Furthermore, these code generation systems are usually tuned for control dominated systems, and therefore are unable to leverage optimization techniques available for data flow aspects of a target hardware architecture.

DSP code generation tools can capture complete software systems, and can perform semantic analysis of the software systems along with related optimizations. DSP code generation tools are also capable of capturing complete software system functionality, so modification of generated code may not be necessary. However, DSP code generation tools are only capable of generating code for data dominant portions of software systems. Control and communication aspects of a software system typically must still be hand coded by a specialized programmer when using DSP code generation tools.

### SUMMARY OF THE INVENTION

A goal of the present invention is to allow programmers to build software systems without regard to a specific target hardware architecture on which the software system will be implemented. An aspect of this is a high-level, coordination-centric, design methodology that permits programmers to explicitly declare the way control and data interactions between software components are coordinated. In other words, a programmer can explicitly declare a set of control and data flow interactions between and among software components.

Coordination-centric design separates control and data, but in a fashion that provides somewhat general encapsulation for programming ease. Coordination centric design accomplishes this by providing separate control and data primitives for building simple coordinators and coordination interfaces that together encapsulate complete coordination protocols. A coordination-centric software system comprises components and coordinators. Components are functional blocks, or objects, and coordinators are objects that regulate control and dataflow interactions between components. Coordinators and coordination interfaces can be composed hierarchically, allowing designers to use well understood components to build new more sophisticated protocols. In coordination-centric design, components are connected to coordinators through coordination interfaces that contain control and data flow primitives through which coordination can occur. All encapsulation is dissolved in a synthesis step, allowing tools full access to an explicit control/data separation.

Coordination synthesis transforms this abstract coordination into concrete interactions for interaction protocols provided by a target hardware architecture and further generates runtime support for systems of interconnected software components. Coordination synthesis generates selectively optimizable implementation code to implement the coordination-centric software application on a chosen target architecture, and generates appropriate coordination code to implement the coordination scheme for the software application with the target hardware architecture's supported interaction protocols (e.g., communication, distributed shared memory (DSM), etc.).

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 shows a coordination interface with two message ports and a control port.

FIG. 2 shows part of a coordinator for round-robin resource allocation.

FIG. 3 shows various types of nodes that can be used in a coordination graph.

FIG. 4 shows a coordination graph with action nodes, mode nodes, activation edges, and guard edges.

FIG. 5 shows a coordination graph with two constraint edges.

FIG. 6A shows an optimizable coordination graph.

FIG. 6B shows the coordination graph of FIG. 6A with modes connected by static binding edges merged to optimize the graph.

FIG. 7 shows a temporal graph that can be used to characterize temporal aspects of coordination centric software systems.

FIG. 8A shows a target hardware architecture.

FIG. 8B shows an architecture graph representing the target hardware architecture shown in FIG. 8A.

FIG. 9 shows a coordination graph partitioned across a distributed architecture with three processors.

FIG. 10 shows a table that can be used to match available target architecture templates to available software subgraphs for implementing crossing edges.

FIG. 11, shows the coordination graph from FIG. 9 with replacement subgraphs for both crossing edges.

FIG. 12 shows an implementation of shared state coordination through the use of a three phase handshake.

FIG. 13 shows a diagram for a software system with a consumer component and two producer components and a “ping/pong” coordinator and a target hardware architecture with two microcontrollers connected by an RS232 connection.

FIG. 14 shows a mapping between the software system and the target hardware architecture of FIG. 13 in which each software component is mapped to a hardware component, and the coordinator is mapped to the RS232 connection between the hardware components.

FIG. 15 shows an alternate mapping between the software system and target hardware architecture of FIG. 13.

FIG. 16 shows all coordination graph elements in both consumer components, the producer components, and the ping/pong coordinator of the software system shown in FIG. 13.

FIG. 17 shows the behavior of the software system of FIG. 13 as a well-formed coordination graph, with hierarchical boundaries removed, ports compressed out of existence, and modes merged as appropriate.

FIG. 18 shows a coordination graph with appropriate replacement subgraphs for the well-formed coordination graph shown in FIG. 17 in response to the mapping shown in FIG. 14 between the software system and the target hardware architecture of FIG. 13.

FIG. 19 shows a coordination graph with appropriate subgraph replacements for the well-formed coordination graph shown in FIG. 17 in response to the mapping shown in FIG. 15 between the software system and the target hardware architecture of FIG. 13.

FIG. 20 shows the appropriate runtime systems for each microcontroller of the target hardware architecture of FIG. 13 for the coordination graph shown in FIG. 19 that corresponded to the mapping shown in FIG. 15.

### DETAILED DESCRIPTION OF PREFERRED EMBODIMENTS

1. Coordination-Centric Design

Coordination-centric design is a component-based design methodology that allows designers to reason about the behavior of their system at a high level which facilitates the reuse of software. An aspect of this methodology is a separation of control and dataflow in an unobtrusive fashion so that designers can concentrate on high-level system behavior without spending a great deal of effort manually separating control and dataflow.

In coordination-centric design, systems are composed of components and coordinators. Components are hierarchical functional blocks or objects, while coordinators are elements, or objects, that regulate control and dataflow interactions between components. Components are connected to coordinators through coordination interfaces that contain primitives, for transferring control and dataflow, through which coordination can take place.

A. Separating Control and Data

In hardware systems, greater reusability and better optimizations can result from separating elements of the system that deal with control from those that deal with dataflow. Similar separation of control and dataflow can likewise benefit the design of software systems. One reason software systems do not typically employ explicit separation of control and dataflow is because explicit separation may expose programmers to higher degrees of complexity, and can interfere with modular design of a system.

For example, procedure calls make up a natural form of coordination between software modules, but procedure calls have both control and data aspects. The control aspect causes the caller to block, awaiting the return values from the callee, and the callee to arrange calls so that they don't collide. Normally, a programmer does not need to concern herself with these details. The programmer only needs to know that the caller component will continue after the procedure call with any data obtained by the call. Unfortunately, protocols such as procedure call are limited in their generality, and by using those protocols, a programmer must often deal with explicit control and data at higher level of the design of the software system.

An aspect of coordination-centric design is to separate control and data, in a fashion that provides fairly general encapsulation for programming ease, by providing separate control and data primitives for building simple coordinators and coordination interfaces that together can encapsulate complete coordination protocols. Coordinators and coordination interfaces preferably can be composed hierarchically, allowing designers to use well understood capsules to build newer and more sophisticated protocols. All encapsulation can be dissolved in a synthesis step, allowing design, simulation, debugging and synthesizing tools full access to an explicit control/data separation.

B. Coordination Interfaces

Coordination interfaces provide a formal means of connection between components and coordinators. Coordination interfaces can contain various types of ports. Preferably the types of ports witch may be included in a coordination interface are as follows: control ports; state ports; and message ports. Furthermore, coordination interfaces can be composed in a hierarchical manner thus allowing a complex coordination interface to be composed of well understood simpler coordination interfaces.

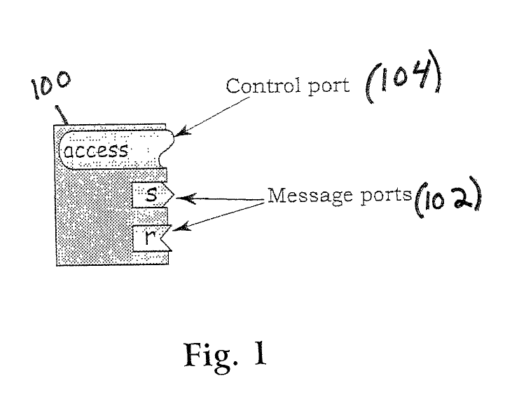

FIG. 1 shows a coordination interface 100 with two message ports 102 and a control port 104. This coordination interface 100 can be used to connect a component to a wide variety of resource allocation protocols such as, for example, round-robin or first come first serve.

C. Coordinators

Coordinators provide abstract representations of component interactions and coordination protocols (for example, procedure-call, round-robin, subsumption, etc.). With these, all relationships between events, control changes, and messages are made explicit, rather than implicit or hidden in source statements.

Coordinators preferably contain coordination interfaces, actions (event triggered code segments), modes (boolean guards on actions), variables, temporal relations, and optionally other coordinators, i.e. coordinators can be composed hierarchically. The temporal relations describe the relative ordering of coordinator elements.

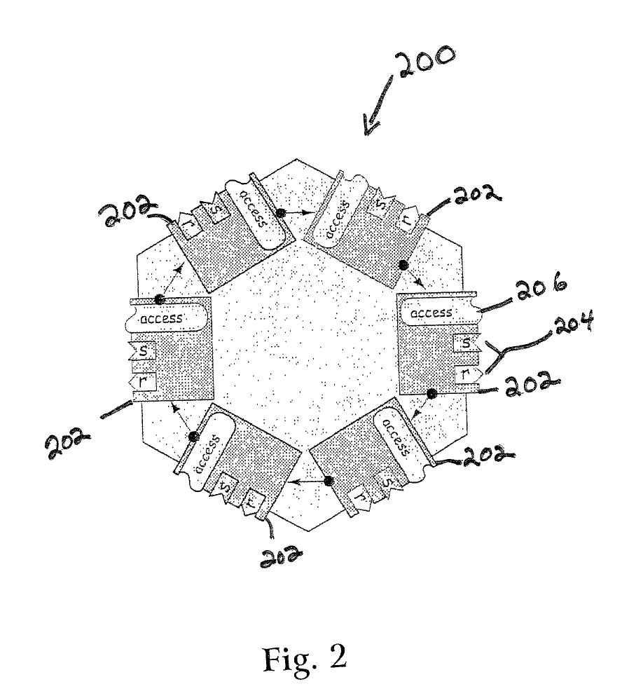

FIG. 2 shows part of a coordinator 200 for round-robin resource allocation. Coordinator 200 provides a set of coordination interfaces 202 that are complimentary to coordination interface 100 shown in FIG. 1, meaning each coordination interface 202 has two message ports 204 that correspond to message ports 102 of coordination interface 100 and a control port 206 that corresponds to control port 104.

D. Components

Components describe distinct functional blocks, or objects, within a coordination-centric software system. Components may be a simple element, such as a fast Fourier transform (FFT), or a component may be a complete software application, such as an address book or a web browser. Components preferably contain coordination interfaces, actions (event triggered code segments), modes (boolean guards on actions), variables, and optionally coordinators and other components, allowing components to be formed hierarchically.

2. Coordination Graphs

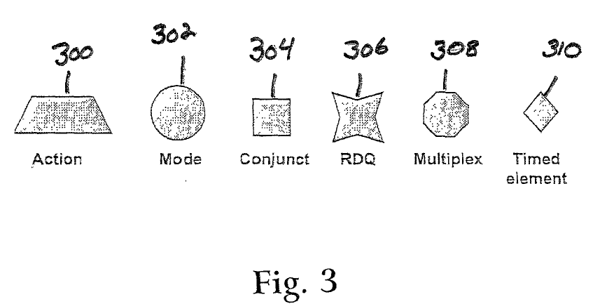

Coordination graphs are abstract system representations that dissolve encapsulation and flatten coordination hierarchy. This makes control/data separation explicit, and provides access to various elements of coordination. Coordination graphs preferably have several types of nodes and edges, as well as rules for what node types can be connected by specific edge types. Associated with coordination graphs are temporal graphs that specify ordering relationships between interacting elements. For a preferred embodiment of the present invention, FIG. 3 shows all types of nodes that can be used in a coordination graph, or a temporal graph, that describes a coordination-centric software system. The preferred set of nodes includes the following: an action node 300 for representing an action within a component or a coordinator; a mode node 302 for representing a mode within a component or a coordinator; a conjunct node 304 for representing a conjunctive guard on a mode or an action; a renaming delay queue node 306 for representing a point where a software generated event is renamed; a mutiplex node 308 for representing a software element that either generates or accepts traffic along a multiplexed communication path between nodes; and a timed element node 310 for representing a partial ordering over system events. A timed element node 310 is used in a temporal graph that accompanies a coordination graph.

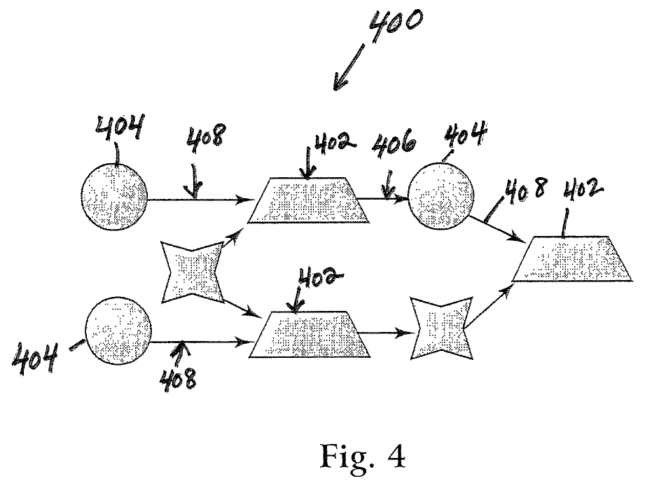

FIG. 4 shows a coordination graph 400 with action nodes 402, mode nodes 404, activation edges 406, and guard edges 408. Activation edges 406 must have modes on the head and either actions or modes on the tail. Guard edges 408 must have modes on the tail end, and actions on the head.

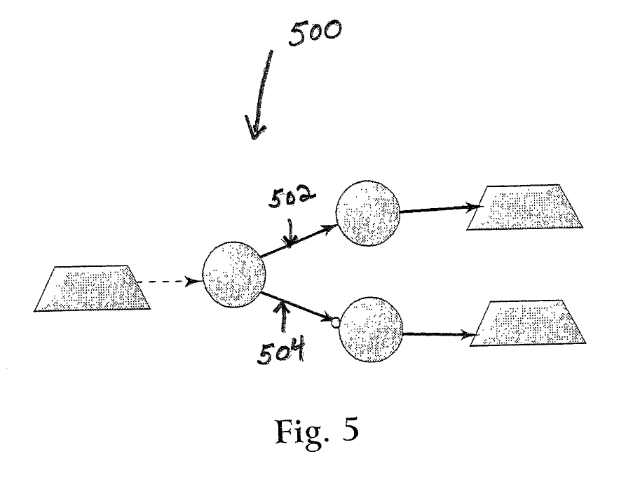

FIG. 5 shows a coordination graph 500 with two constraint edges 502. Constraint edges 502 can either directly connect two modes or they can connect modes through a conjunctive node 304 (FIG. 3). A conjunctive node 304 can have input and output constraint edges (not shown), and a conjunctive node 304 enforces an outgoing constraint edge (not shown) when all incoming constraint edges (not shown) are satisfied.

A. Optimizations Based On Coordination Graphs

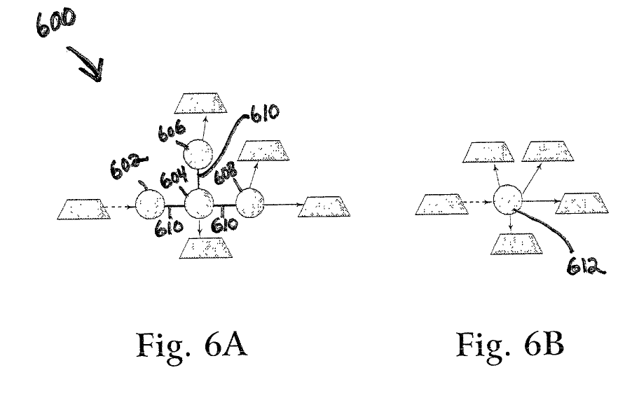

Many optimizations can be performed on coordination graphs to reduce the total number of nodes, and the complexity of networks within the graph. For example, FIG. 6A shows an optimizable coordination graph 600. With reference to FIG. 6A, mode nodes 602, 604, 606, and 608 can be merged because they are all connected by static binding edges 610. Mode nodes 602, 604, 606, and 608 can be merged because a static binding edge causes the bound modes to all either be on or off at the same time, and for purposes of a coordination graph can be represented as a merged mode node 612, as shown in FIG. 6B, that acts as a boolean guard on each action that was bound to one of mode nodes 602, 604, 606 and 608.

B. Temporal Graphs

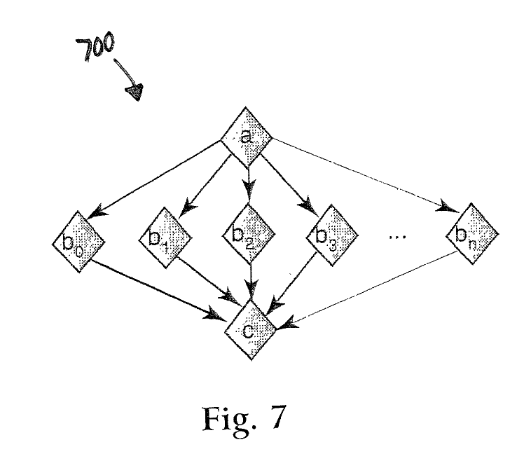

Temporal aspects of coordination are represented through temporal graphs such as temporal graph 700 shown in FIG. 7. These are directed graphs that represent a partial order of all interaction elements for all coordinators represented by a system's coordination graph.

3. Architecture Graphs

Implementation architectures also can preferably have graph representations. In this way a software functionality partition can be represented as a mapping between a coordination graph and an architecture graph. Mappings, in this context, are directed connections between elements in two different graphs. Mappings can connect nodes to nodes, nodes to edges, edges to edges, and edges to nodes. With architecture graphs, nodes represent complete hardware components, and edges represent direct communication paths between hardware components.

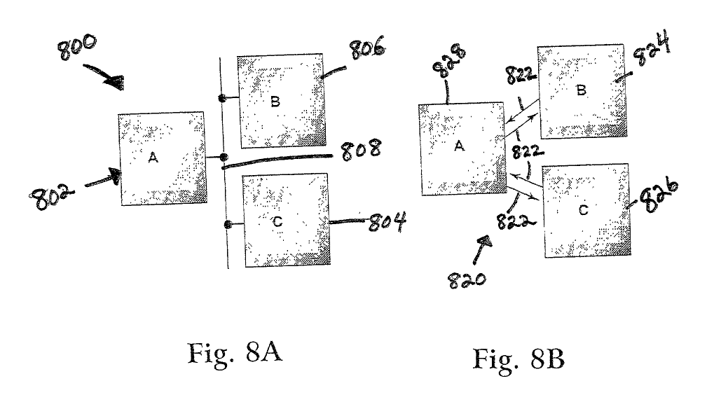

FIG. 8A shows a target hardware architecture 800. With reference to FIG. 8A, target hardware architecture 800 has processing resources 802, 804 and 806 all of which are connected by a interaction protocol, or bus, 808. FIG. 8B shows an architecture graph 820 representing target hardware architecture 800, as shown in FIG. 8A. With reference to FIG. 8B, architecture graph 820 is preferably abstracted from a coordination-based system model of target hardware architecture 800. Architecture graph 820 abstractly describes the expected response of target hardware architecture 800 to stimulus from the overall system.

In architecture graph 820, each connection between processing resources 802, 804 and 806, of target hardware architecture 800, is represented explicitly, as an edge 822 connecting the nodes 832, 834, and 836 that represent processing resources 802, 804, and 806, respectively. In FIG. 8A processing resources 804 and 806 can both communicate with processing resource 802 via bus 808. Thus in hardware graph 820 nodes 824 and 826 are each connected to node 828 by two edges 822 that allow communication in opposite directions. For example, if three components (not shown) are connected through a hardware bus (not shown) such that any component can talk to any other, the architecture graph (not shown) will require six separate edges (not shown) to appropriately represent the corresponding hardware architecture. Just as coordination graphs can be automatically derived from a coordination-based software description, architecture graphs can be automatically derived from a coordination-based architecture model (not shown).

4. Coordination Synthesis

Once designers define target hardware architectures and software system functionality, they add high-level mappings between the software system and the target hardware architecture. Generally speaking, this is done by mapping between the software components and the architecture components, and mapping between software coordinators and architecture components or coordinators.

A. High-Level Mapping

Behavioral models are mapped to target models, which can include hardware, operating systems, various communication protocols, and at times other high-level models. A mapping is a set of maps. A maps is an ordered pair, each holding a specification element (either a specification component or coordinator), and an architectural component, or processing resource, such as a micro-processor or a digital signal processor (DSP), for example, or an interaction protocol (e.g., communication protocol, DSM).

Legal maps are between software specification components and target hardware architecture components, between software specification coordinators and target hardware architecture components, and between software specification coordinators and the interaction framework, or interaction protocol, of the target hardware architecture.

A complete mapping has a map for each element of the software system and its corresponding element of the target hardware architecture.

B. Partitioning Coordination Graphs

Coordination graphs are preferably partitioned into equivalence classes. In this context equivalence relates to hardware resources to which individual software nodes in the coordination graph are mapped, i.e. the coordination graph can be broken into portions based on those portions having been mapped to equivalent processing resources. Because coordinators can be mapped to protocols, or interaction frameworks, regulating communication between processing resources, the nodes that were encapsulated by the coordinators may still need to be mapped to one or more processing resources. In order to do this, a micro-mapping step is performed, in which processing resources are allocated to all software nodes not already mapped to a processing resource.

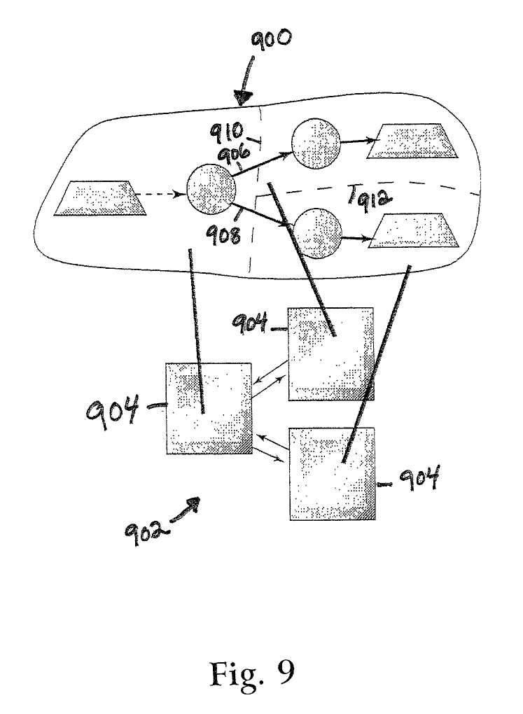

FIG. 9 shows a coordination graph 900 partitioned across a distributed target hardware architecture 902 with three processors 904. Any software edges, in this example shown as crossing edges 906 and 908, that cross a boundary between processors, the boundaries indicated by dashed lines 910 and 912, must be implemented in terms of point-to-point TCP/IP, which in this example is supplied by the target hardware architecture.

Connections between the equivalence classes are guided by a coordination framework provided by distributed target hardware architecture 902. Software edges that cross the boundaries between software nodes in different equivalence classes, which in this example are crossing edges 906 and 908 will normally need to be replaced by a subgraph of software nodes that can implement the communication represented by the crossing edge in terms of the interaction framework, or protocol, provided by distributed target hardware architecture 902.

C. Template-Based Subgraph Replacement

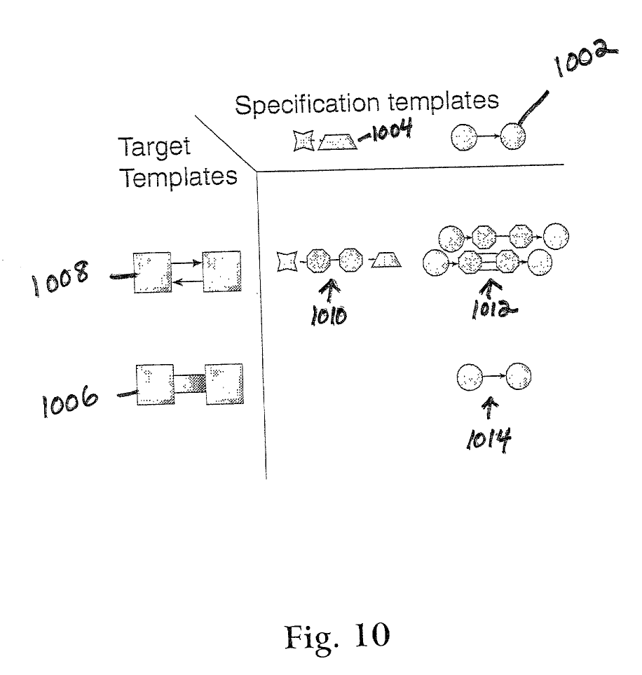

FIG. 10 shows a subgraph replacement table 1000 that can be used to match available target architecture templates to available software subgraphs for implementing crossing edges. A replacement algorithm uses template matching against subgraphs surrounding crossing edges, and the appropriate coordination edges in target architecture. With reference to FIG. 10, subgraph replacement table 1000 has two specification templates 1002 and 1004 and two target templates 1006 and 1008, and for each cross point in the table there are a set of potential replacements 1010, 1012, and 1014. The replacement algorithm will choose an appropriate replacement from the set based on a mixture of cost constraints placed against the specification, and the impact each potential replacement 1010, 1012, and 1014 will have on the system as a whole. For example, if a path in the coordination graph is given a response time of 800 ms typically as either a guarantee or a requirement, then the replacement algorithm can usually choose a high latency implementation from the replacement set that increases response time, but uses a minimal amount of system time. On the other hand, if the path needs to have a response time of 1 ms, then the replacement algorithm may need to choose an implementation from the replacement set that has low latency, but that takes a great deal of time away from other resources.

(a) Template Matching

Template matching is preferably performed in two phases: column matching, and row matching. Column matching selects all known implementations of a given subgraph, and row matching selects the implementations appropriate for the given architecture. In both cases, matching is performed with the marked edges and looks outward to the nodes attached. Several templates may match subgraphs surrounding a given edge, and the tool must choose between the templates that match.

(b) Cost Functions

Each alternative from a template match has an associated cost. This cost is often dynamic, given other decisions made in template selection. A goal of template matching is to select the set of replacement subgraphs that results in the lowest cost.

(c) Multiplexing Shared Communication Paths

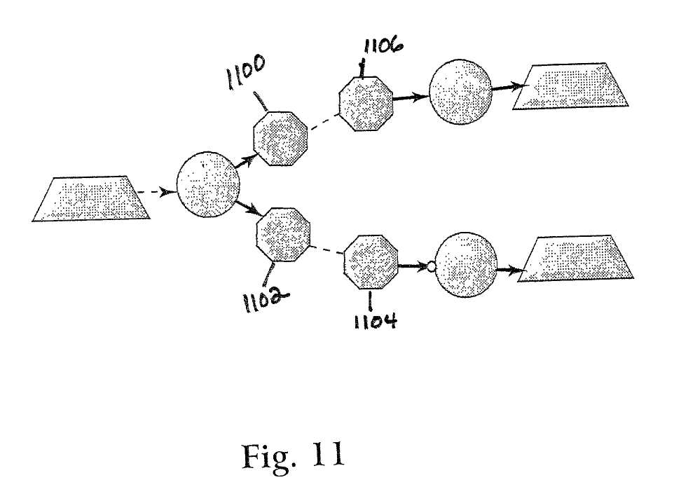

FIG. 11, shows coordination graph 900, from FIG. 9 with replacement subgraphs for crossing edges 906 and 908. In this example the replacement subgraph includes multiplex nodes 1100, 1102, 1104, and 1106 which implement crossing edges 906 and 908 in terms of the interaction protocol provided by distributed target hardware architecture 902 of FIG. 9. This approach has the advantage of allowing a larger number of high-level paths to be used than the number provided by the underlying implementation architecture. By multiplexing the available architectural paths, this approach allows several high level paths (in the software) to use the multiplexed architectural paths. This can usually be accomplished through the use of an addressing mechanism. Multiplex terminals (the nodes that either generate or accept traffic through a multiplexed path) are represented by octagonal nodes 1100, 1102, 1104, and 1106. Multiplex terminals are then mapped to specific paths in the architecture graph.

Often, several co-mapped multiplex terminals will generate traffic at the same time. In this case, the traffic may be placed into a single low-level message and transmitted together.

Below are several examples of replacements, shown to illustrate various aspects of the present invention.

(d) Sharing State Across Communication Paths

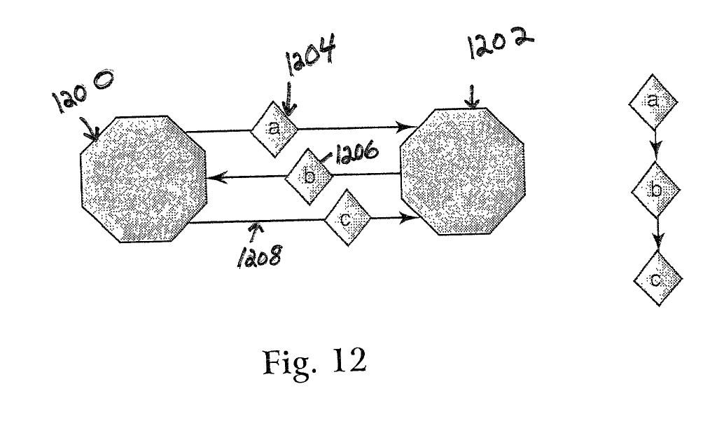

A benefit of the present invention is that state can be transparently shared among entities that are connected only through communication paths. In accordance with the present invention, state sharing is implemented through a replacement subgraph in a coordination graph. FIG. 12 shows an implementation of shared state coordination through the use of a three phase handshake. This replacement can be used for any static edge that crosses between two separate architectural components, replacing them with multiplex nodes 1200 and 1202. The implementation shown uses three-phase handshake message/transaction based coordination, and causes the system to block until the transaction is complete. The transaction begins with a transition request message 1204 sent out to all participants, followed by an acknowledgement (ACK) or a non-acknowledgement (NACK) from all participants in message 1206. Based on this, the initiator sends either a commit message or an abort message 1208. The logic for appropriate behavior based on message return type is embedded in a number of modes and actions that are isolated from the application side of the system.

(e) Using Shared State for Communication

If the implementation target provides only state based coordination (e.g., shared memory or distributed shared memory (DSM)), inter-component communication must be implemented using the available state based coordination method. Inter-component communication can preferably be implemented by arranging the shared state as a sequence of shared buffers. The implementation architecture will normally provide primitives for synchronizing accesses to the shared buffers, and using the provided primitives or other well known techniques, the buffers can be treated as a message media.

5. Generating Implementation Code

A final code generation stage generates software implementation code (e.g., C, C++, Java, assembly, etc.) to perform the specified functionality on the given targets. Code generation is performed by walking the coordination graph, generating target source code for each node, and then generating a run-time system to wrap around this.

6. Two Producer/One Consumer Example

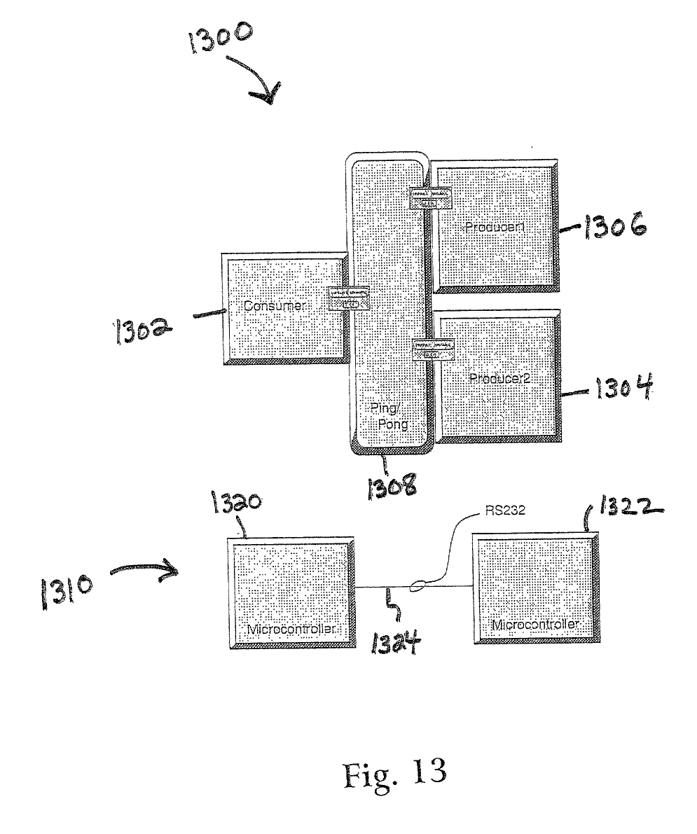

FIG. 13 shows a diagram for a software system 1300 with a consumer component 1302 and two producer components 1304 and 1306 and a “ping/pong” coordinator 1308. Ping/pong coordinator 1308 insures that consumer component 1302 receives values from each producer component 1304 and 1306 in an alternating sequence (e.g., a value from producer component 1304, then a value from producer 1306, etc.). Each of the components is preferably designed and implemented in isolation, meaning without concern for the behavior of any other software elements with witch it may interact in a software system. As shown in FIG. 13, software system 1300 does not have any connection between its intended behavior and a target hardware architecture 1310. Target hardware architecture 1310, in this example has two microcontrollers 1320 and 1322 connected by an RS232 connection 1324.

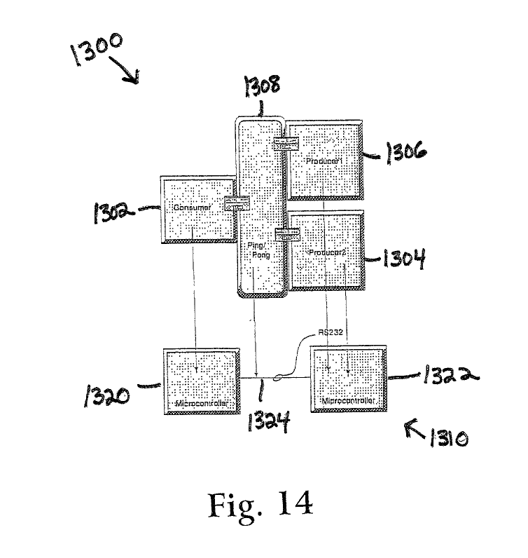

Once the behavior is completely described, and an architecture is chosen, the behavior is mapped to the architecture. A designers can experiment with different mappings of software system 1300 to target hardware architecture 1310 without having to change the way in which the components of software system 1300 interact and behave. FIG. 14 shows a mapping from software system 1300 to target hardware architecture 1310. Each component 1302, 1304, and 1306 is mapped to a hardware component, either microcontroller 1320 or microcontroller 1322. Pin/pong coordinator 1308 is mapped to the RS232 connection 1324 between the microcontrollers. This example mapping places the both producer components 1304 and 1306 together on microcontroller 1322. While consumer component 1302 is mapped to microcontroller 1320.

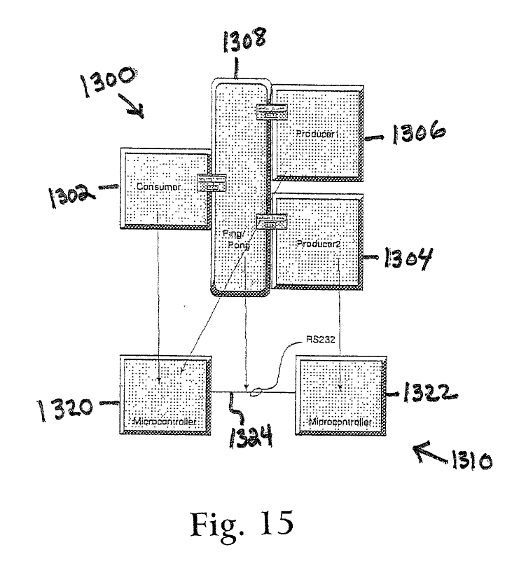

FIG. 15 shows an alternate mapping between software system 1300 and target hardware architecture 1310. In this mapping producer component 1304 is mapped to microcontroller 1322, while consumer component 1302 and producer component 1306 are both mapped to microcontroller 1320. Again ping/pong coordinator 1308 is mapped to RS232 connection 1324.

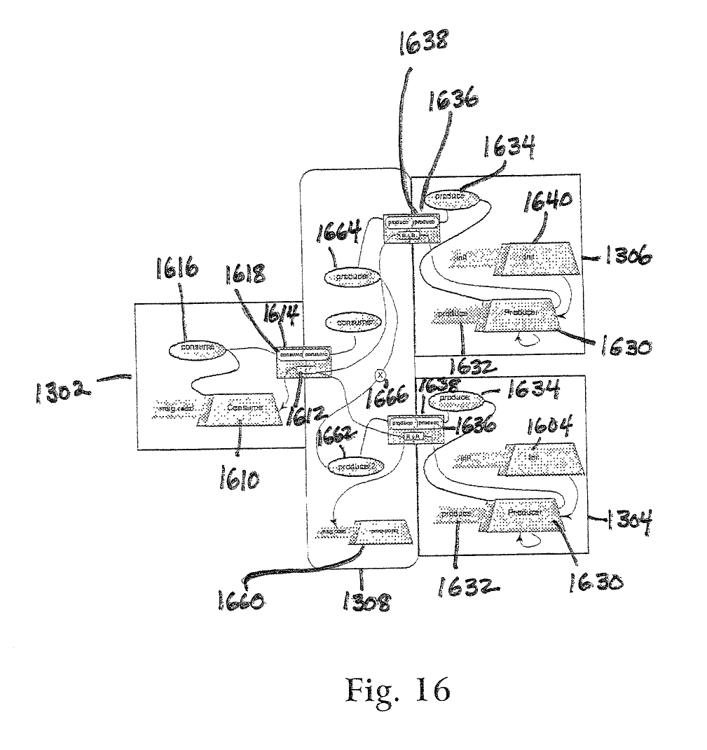

FIG. 16 shows all coordination graph elements in consumer component 1302, producer components 1304 and 1306, as well as the coordination graph elements in ping/pong coordinator 1308. Consumer component 1302 has a consume action 1610 that is triggered by data arriving on a message port 1612 of a coordination interface 1614, and a consume mode 1616 that is controlled by a control port 1618 of coordination interface 1614. Producer components 1304 and 1306 each have a “producer” action 1630 that is triggered by a repetitive “produce” event 1632. These actions are enabled by a produce mode 1634 that is controlled by ping/pong coordinator 1308 through a control port 1636 of coordination interface 1638. Producer components 1304 and 1306 each have an “init” action 1640 to kick start produce event 1632. Ping/pong coordinator 1308 has a single action 1660 that repeatedly toggles its producer modes 1662 and 1664 (hence toggling which producer component 1304 or 1306 is currently active). There is a “mutex” constraint 1666 between producer modes 1662 and 1664 of pin/pong coordinator 1308 to ensure that producer modes 1662 and 1664 are never simultaneously active.

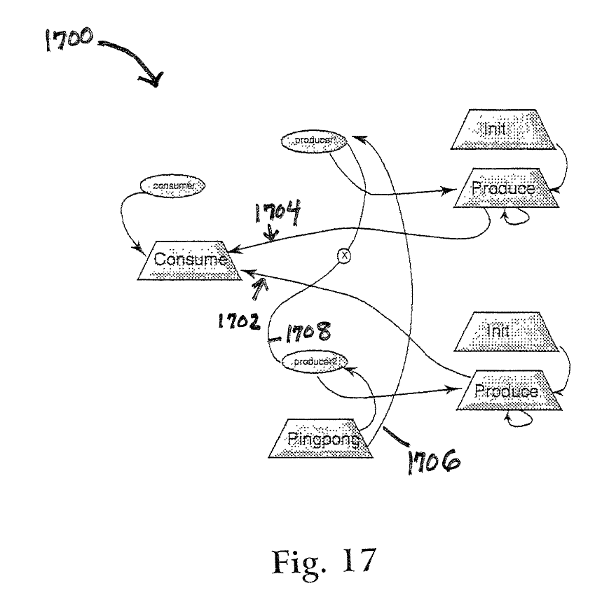

FIG. 17 shows the behavior of the above software system as a well-formed coordination graph 1700, based on the coordination graph elements shown in FIG. 16. Hierarchical boundaries between consumer component 1302, producer components 1304 and 1306, and ping/pong coordinator 1308 have been removed. Message and control ports that were part of coordination interface 1614 and coordination interfaces 1638 have been compressed out of existence, i.e. coordination interfaces have been replaced with bindings between coordination graph elements that were effectively bound through the coordination interfaces in the coordination-centric software system. Furthermore, modes have been merged as appropriate under the condition described with reference to FIGS. 6A and 6B. The process to this point has been independent of target hardware architecture 1310.

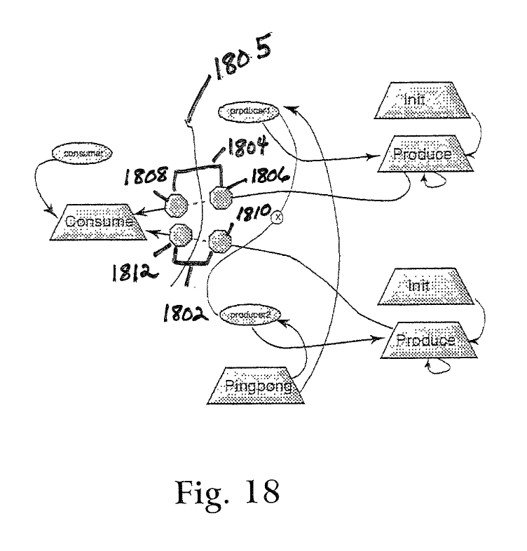

FIG. 18 shows a coordination graph 1800 with appropriate replacement subgraphs 1802 and 1804 for well-formed coordination graph 1700 in response to the mapping between software system 1300 to target hardware architecture 1310 as shown and discussed with reference to FIG. 14. Each of the edges from the producer actions are cut and replaced by subgraphs that contain multiplex nodes 1806, 1808, 1810, and 1812 because edges 1702 and 1704 (FIG. 17) now cross a boundary between microcontrollers 1320 and 1322, represented in coordination graph 1800 as line 1805. Multiplex nodes 1806 and 1808 will implement edge 1704 in terms of RS232 connection 1324, and multiplex nodes 1810 and 1812 will implement edge 1702 in terms of RS232 connection 1324. The edges shown as replacement subgraphs 1802 and 1804 are transient edges and there is no need to provide a state consistency protocol along them.

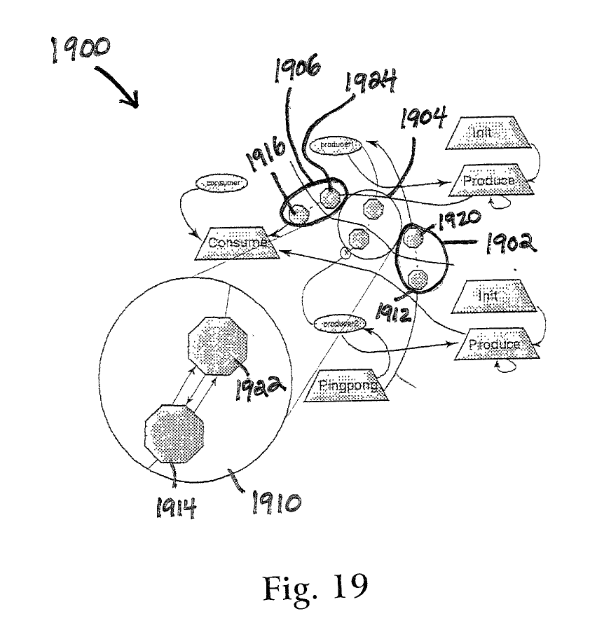

FIG. 19 shows a coordination graph 1900 with appropriate subgraph replacements 1902, 1904, and 1906 for a mapping of software system 1300 to target hardware architecture 1310, as shown and described with reference to FIG. 15. Here, three crossing edges 1704, 1706 and 1708 (FIG. 17) must be cut: two transients 1704 and 1706, and one constraint 1708. As shown in the magnified section, subgraph replacement 1904 is a consistency protocol 1910 applied to replace constraint edge 1708.

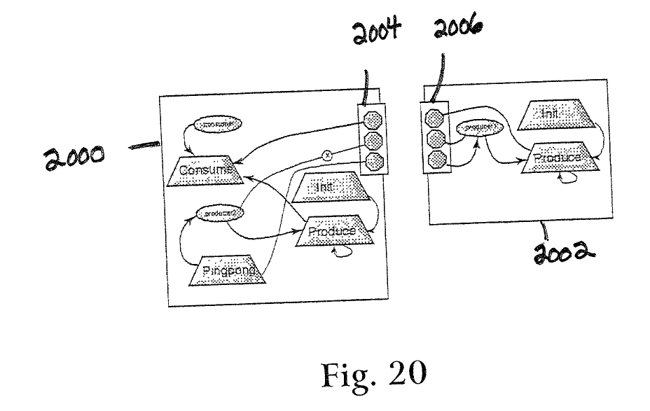

In the final steps of coordination synthesis, a runtime system 2000 is generated for microcontroller 1320 and a runtime system 2002 is generated for microcontroller 1322. FIG. 20 shows the appropriate runtime systems 2000 and 2002 for the coordination graph in FIG. 19 that corresponded to the mapping in FIG. 15. Runtime systems 2000 includes an event manager 2004 which contains multiplex nodes 1912, 1914 and 1916 (FIG. 19). Run time system 2002 includes an event manager 2006 containing multiplex nodes 1920, 1922, and 1924 (FIG. 19). Both runtime systems 2000 and 2002 contain implementations of all graph elements mapped to their respective microcontrollers as shown and describe with reference to FIGS. 19 and 15.

It will be obvious to those having skill in the art that many changes may be made to the details of the above-described embodiments of this invention without departing from the underlying principles thereof. The scope of the present invention should, therefore, be determined only by the following claims.

1. A method of implementing a software application on a target hardware architecture having a first and second processing resource and a predetermined interaction protocol between the first and second processing resources, comprising:
designing a software system independent of the target hardware architecture, the software system including a first and a second functional object each performing a predetermined action, a coordination object for regulating control and dataflow interactions between the first and second functional objects, a control object for handling control interactions between one of the functional objects and the coordination object, and a dataflow object for handling dataflow interactions between one of the functional objects and the coordination object;
creating a software graph based on the software system, in which the first functional object is represented as a first set of software nodes in which a first action and a first mode within the first functional object are represented as a first action node and a first mode node, respectively, and in which the second functional object is represented as a second set of software nodes, in which a second action and a second mode within the second functional object are represented as a second action node and a second mode node, respectively, and in which the coordination object is represented as a set of coordination nodes in which a coordination action is represented as a coordination action node and a coordination mode is represented as a coordination mode node, and in which the dataflow object is represented as a dataflow edge connecting one of the software nodes within the first and second sets of software nodes to one of the coordination nodes within the set of coordination nodes, and the control object is represented as a control edge connecting one of software nodes within the first and second sets of software nodes to one of the coordination nodes within the set of coordination nodes;
creating a hardware graph based on the target hardware architecture wherein the first processing resource is represented as a first hardware node, the second processing resource is represented as a second hardware node and the interaction protocol is represented as a hardware edge connecting the first and second hardware nodes; and
mapping the software graph to the hardware graph, wherein the first set of software nodes is mapped to the first hardware node, the second set of software nodes is mapped to the second hardware node, the set of coordination nodes are mapped to the first hardware node and one of the control and dataflow edges is mapped to the hardware edge.

2. A method according to claim 1 further comprising replacing the one of the control and dataflow edges that has been mapped to the hardware edge with a first replacement node mapped to the first hardware node and a second replacement node mapped to the second hardware node, for implementing said edge in terms of the interaction protocol provided by the target hardware architecture.

3. A method according to claim 2 in which the first and second replacement nodes are chosen from a set of replacement nodes based upon the type of edge being replaced and the interaction protocol provided by the target hardware architecture.

4. A method according to claim 3 further comprising generating implementation code for the first processing resource based on the first set of software nodes, the set of coordination nodes, and the first replacement node that were mapped to the first hardware node, and generating implementation code for the second processing resource based on the second set of software nodes that were mapped to the second hardware node.

5. A method according to claim 1 of implementing the software system on a second target hardware architecture having three processing resources and a predetermined first interaction protocol between a first and a second processing resource of the three processing resources and a predetermined second interaction protocols between the second and a third of the three processing resources further comprising:
creating a second hardware graph based on the second target hardware architecture wherein the first of the three processing resource is represented as a first hardware node, the second processing resource of the three processing resources is represented as a second hardware node, the third processing resource of the three processing resources is represented as a third hardware node, the predetermined first interaction protocol is represented as a first hardware edge connecting the first and second hardware nodes, and the predetermined second interaction protocol is represented as a second hardware edge connecting the second and third hardware nodes;
mapping the software graph to the second hardware graph, wherein the first set of software nodes are mapped to the first hardware node, the second set of software nodes are mapped to the third hardware node, the set of coordination nodes are mapped to the second hardware node, a crossing dataflow edge connecting one of the coordination nodes to one of the software nodes of the first set of software nodes is mapped to the first hardware edge, and a crossing control edge connecting one of the coordination nodes to one of the software nodes of the second set of software nodes is mapped to the second hardware edge;
replacing the crossing dataflow edge with a first data replacement node mapped to the first hardware node and a second data replacement node mapped to the second hardware node for implementing the crossing dataflow edge in terms of the predetermined first interaction protocol; and
replacing the crossing control edge with a first control replacement node mapped to the second hardware node, and a second control replacement node mapped to the third hardware node for implementing the crossing control edge in terms of the predetermined second interaction protocol.

6. A method according to claim 5 in which in which the first and second data replacement nodes and the first and second control replacement nodes are chosen from a set of replacement nodes based upon the interaction protocols provided by the target hardware architecture.

7. A method according to claim 6 further comprising:
generating implementation code for the first processing resource based on the first set of software nodes and the first control replacement node;
generating implementation code for the second processing resource based on the set of coordination nodes, the second data replacement node, and the first control replacement node; and
generating implementation code for the third processing resource based on the second set of software nodes and the second control replacement node.

8. A system for generating an executable version of a software application for use with a target hardware architecture having a plurality of processing resources and an interaction protocol for controlling information exchanges between the processing resources, the software application being designed independent of the target hardware architecture, the system comprising:
a software application design tool for building software applications based on functional requirements and explicit coordination characteristics;
a software graphing tool that generates a coordination graph based on the software application, in which first and second functional components of the software application are represented as first and second software nodes, respectively, first and second software nodes having a node type that is based on a function performed by the respective functional component, and in which an information exchange between the first and second functional components is represented as a software edge connecting the first and second software nodes, and the software edge has an edge type that is based on the type of information exchange it represents;
a hardware graphing tool for generating a target hardware graph based on the target hardware architecture, in which first and second computational resources are represented as first and second hardware nodes, respectively, and the interaction protocol which controls information exchanges between the processing resources is represented as a hardware edge connecting the first and second software nodes;
a mapping tool in which the first and second software nodes are mapped to first and second hardware nodes, respectively, and the software edge is mapped to the hardware edge, and first and second replacement nodes are mapped to first and second hardware nodes, each replacement node representing a functional replacement component that will implement the information exchange represented by the software edge in terms of the interaction protocol represented by the hardware edge, and will pass any interactions to the respective first and second components; and
a code synthesizing tool in which an executable version of the first functional and functional replacement components will be generated for use on the first processing resource and an executable version of the second functional and functional replacement components will be generated for use on the second processing resource.
